(19) United States
(12) Patent Application Publication
(10) Pub. No.: US 2021/0376339 A1
(43) Pub. Date: Dec. 2, 2021

(54) ELECTROCHEMICAL HYDROGEN PUMP

(71) Applicant: Panasonic Intellectual Property Management Co., Ltd., Osaka (JP)

(72) Inventors: Norihiko KAWABATA, Osaka (JP); Osamu SAKAI, Osaka (JP); Kunihiro UKAI, Nara (JP); Takayuki NAKAUE, Osaka (JP)

(21) Appl. No.: 17/288,094

(22) PCT Filed: Nov. 1, 2019
(86) PCT No.: PCT/JP2019/043015

§ 371 Date: Apr. 23, 2021

(30) Foreign Application Priority Data
Nov. 6, 2018 (JP) 2018-208958

(51) Int. Cl. H01M 8/04089

(52) U.S. Cl. CPC H01M 8/04097

(57) ABSTRACT

This invention provides an electrochemical hydrogen pump which allows reduction efficiency due to increase of contact resistances to be suppressed with a light-weight and compact structure. An electrochemical hydrogen pump (24) comprises: single battery cells (m1-m3) that each include an anode separator (7), an anode diffusion layer (5), an anode electrode layer (3), an electrolyte membrane (2), a cathode electrode layer (4), a cathode diffusion layer (6), and a cathode separator (8); and pressurization spaces that are provided in positions sandwiching the anode diffusion layer and the cathode diffusion layer therebetween. The pressurization spaces include an anode pressurization space (27) provided in an anode-side member and a cathode pressurization space (28) provided in a cathode-side member.

### TECHNICAL FIELD

The present disclosure relates to an electrochemical hydrogen pump that compresses hydrogen.

### BACKGROUND ART

Hydrogen-fueled household fuel cells are becoming more and more popular as their development progresses. In recent years, mass production and commercialization of hydrogen-fueled fuel cell vehicles has begun, similar to household fuel cells. However, while household fuel cells can use existing city gas and commercial electricity, hydrogen infrastructure is essential for fuel cell vehicles.

Therefore, in order for fuel cell vehicles to expand and spread in the future, it is necessary to expand hydrogen stations as hydrogen infrastructure. However, the current hydrogen stations require large-scale facilities and land, which are very expensive. This is a major issue that needs to be solved in order for fuel cell vehicles to spread.

Therefore, the development of a compact and inexpensive small hydrogen filling apparatus for household use is desired as an alternative to large hydrogen stations. The most important thing in the development of this small hydrogen filling apparatus is the development of a compressor to compress the hydrogen, and electrochemical hydrogen pumps that can boost hydrogen electrochemically are currently attracting attention.

Electrochemical hydrogen pumps have many advantages over known mechanical hydrogen compression apparatuses, such as compactness, high efficiency, no need for maintenance due to the absence of mechanically operated parts, and almost no noise, and their development and commercialization are eagerly awaited.

The method currently envisioned for a small hydrogen refueling system is to use an electrochemical hydrogen pump to electrochemically compress hydrogen generated using the fuel reformer of a household fuel cell when the cell is not in operation as a fuel cell. According to such an electrochemical hydrogen pump, in addition to the advantages mentioned above, there are also the following advantages.

Specifically, while the concentration of hydrogen that can be generated using a fuel reformer is at most 75%, the electrochemical hydrogen pump can generate hydrogen at almost 100% concentration, which is required for fuel cell vehicles. In addition, the electrochemical hydrogen pump can, in principle, boost the pressure of the hydrogen to a level high enough to fill a fuel cell vehicle.

In addition, the structure of the electrochemical hydrogen pump is almost the same as the power generation stack in a household fuel cell. Therefore, the production line for the components of the fuel cell, which is already in mass production, can be used as is, and the cost of the components may be reduced.

On the other hand, unlike the fuel cell power generation stack, the electrochemical hydrogen pump requires a special structure to support the electrolyte membrane interposed between the anode and cathode poles. The reason for this is that the pressure at the cathode electrode needs to be extremely high compared to the pressure at the anode electrode, where low-pressure hydrogen is supplied, so that the fuel cell vehicle can be filled with hydrogen.

FIG. 1A and FIG. 1B illustrate a structure of a known fuel cell power generation stack 1. FIG. 1A is a schematic sectional view including a cathode inlet/outlet of power generation stack 1. FIG. 1B is a schematic sectional view including an anode inlet/outlet of power generation stack 1.

In power generation stack 1, as illustrated in FIG. 1A and FIG. 1B, single battery cell m1, single battery cell m2, single battery cell m3 are stacked. A single battery cell may be referred to a “single cell” or “cell”. In addition, a case where three single battery cells are stacked is described here, but the number of the single battery cells is not limited to this.

Single battery cell m1, single battery cell m2, single battery cell m3 all have the same structure. Here, as an example, the uppermost single battery cell m1 is described.

In single battery cell m1, electrolyte membrane 2 where anode electrode layer 3 and cathode electrode layer 4 are formed is sandwiched between anode diffusion layer 5 and cathode diffusion layer 6. Further, the outside thereof is sandwiched between anode separator 7 and cathode separator 8.

In addition, for the purpose of preventing leakage of gas to the outside, seal 9b around anode diffusion layer 5, seal 9a around cathode diffusion layer 6, and seal 9c around electrolyte membrane 2 are provided.

Single battery cell m2 and single battery cell m3 have a stacking structure similar to that of single battery cell m1. Single battery cell m3, single battery cell m2 and single battery cell m1 are stacked in this order from the bottom side, and then the outside thereof is sandwiched between anode insulation plate 11 and cathode insulation plate 12. Further, the outside thereof is sandwiched between anode end plate 13 and cathode end plate 14, and then they are fastened with bolt 15 and nut 10.

When this power generation stack 1 is used as a hydrogen pump, anode inlet 16 is used as a low pressure hydrogen supply port, and anode outlet 17 is used for collecting excess low pressure hydrogen. That is, the low pressure hydrogen supplied from anode inlet 16 flows into anode diffusion layer 5 through anode inlet manifold 21a, each single battery cell anode inlet horizontal introduction path 21b, and anode inlet vertical introduction path 21c of each single battery cell. The excess hydrogen is collected from anode outlet 17 through anode outlet vertical introduction path 21d of each single battery cell, anode outlet horizontal introduction path 21e, and anode outlet manifold 21f.

On the other hand, the high-pressure hydrogen in cathode diffusion layer 6 of each single battery cell that is generated through electrochemical reaction described later is removed from cathode inlet 18 through cathode inlet vertical introduction path 22c, cathode inlet horizontal introduction path 22b, and cathode inlet manifold 22a.

It is to be noted that normally, cathode outlet 19 is not used and is therefore sealed, but depending on the situation, the above-mentioned high-pressure hydrogen can be removed from cathode outlet 19 through cathode outlet vertical introduction path 22d, cathode outlet horizontal introduction path 22e, and cathode outlet manifold 22f.

In this manner, with low pressure hydrogen flowing in anode diffusion layer 5, a voltage is applied between anode separator 7 of single battery cell m3 and cathode separator 8 of single battery cell m1 through the use of power source 20. This causes hydrogen to dissociate into protons and electrons in the anode electrode layer 3 of each single battery cell, as shown in Equation 1.

Anode electrode: H₂ (low pressure)→2H⁺+2e⁻ (Equation 1)

Protons dissociated in anode electrode layer 3 travel through electrolyte membrane 2, accompanied by water molecules. On the other hand, the electrons dissociated in anode electrode layer 3 travels from anode diffusion layer 5 through anode separator 7, and travels through other single battery cells and power source 20 to cathode separator 8, cathode diffusion layer 6, and further cathode electrode layer 4.

On the cathode electrode side, as shown in the following Equation 2, a reduction reaction is carried out between protons moving through electrolyte membrane 2 and electrons transmitted from cathode diffusion layer 6 to produce hydrogen. When cathode inlet 18 is closed, the hydrogen gas pressure in the cathode diffusion layer 6 rises, resulting in high pressure hydrogen gas.

Cathode electrode: 2H⁺+2e⁻→H₂ (high pressure) (Equation 2)

The relationship between the pressure P1 of the hydrogen on the anode side, the pressure P2 the hydrogen on the cathode side, and voltage E is shown in the following Equation 3.

E=(RT/2F)ln(P2/P1)+ir (Equation 3)

In Equation 3, R is the gas constant (8.3145 J/K-mol), T is the temperature of the single cell (K), F is Faraday's constant (96485 C/mol), P2 is the cathode side pressure, P1 is the anode side pressure, i is the current density (A/cm²), and r is the single cell resistance (Ω-cm²).

It is clear from Equation 3 that increasing the voltage will increase the pressure P2 of hydrogen on the cathode side.

However, as the pressure of hydrogen on the cathode side, P2, increases and the differential pressure with the pressure of hydrogen on the anode side, P1, increases, the contact pressure between cathode diffusion layer 6 and cathode separator 8 and between cathode diffusion layer 6 and cathode electrode layer 4 decreases and the resistance increases. As a result, the efficiency of the electrochemical hydrogen pump is reduced.

This phenomenon is described with reference to FIG. 1C. FIG. 1C illustrates a part of a sectional view including the cathode inlet/outlet cross power generation stack 1 illustrated in FIG. 1A. FIG. 1C illustrates a state where the space where cathode diffusion layer 6 is housed is expanded due to an increase of pressure P2 of the hydrogen on the cathode side, with only a single battery cell (for example, single battery cell m1).

As illustrated in FIG. 1C, when pressure P2 of the hydrogen on the cathode side increases, force A1 represented by the upward arrow is exerted on cathode separator 8, and force A2 represented by the downward arrow is exerted on anode separator 7. As a result, cathode separator 8 deflects upward, and anode separator 7 deflects downward.

In this manner, the space where cathode diffusion layer 6 is housed expands in the stacking direction (in the drawing vertical direction), and the contact pressures between cathode diffusion layer 6 and cathode separator 8 and between cathode diffusion layer 6 and cathode electrode layer 4 are reduced, and thus, the contact resistance increases. Although the current to boost a certain amount of hydrogen is constant, the voltage required to carry this current becomes larger, and more power is required to boost a certain amount of hydrogen. In other words, the efficiency of the hydrogen pump is reduced.

Therefore, the pressure of hydrogen that can be boosted using the power generation stack 1 as a hydrogen pump is not very high, and therefore, the fuel cell vehicle cannot be sufficiently filled with hydrogen. To solve this problem, a structure has been proposed in which the generating stack of a general fuel cell is used as a hydrogen pump to prevent displacement of the separator even if there is a pressure difference between the high and low pressure sides (see, for example, PTL 1).

FIG. 2 is a schematic sectional view including electrochemical hydrogen pump 23 disclosed in PTL 1. In FIG. 2, the same components as those of FIG. 1A to FIG. 1C are denoted by the same reference numerals.

Electrochemical hydrogen pump 23 is created as follows.

First, in box-shaped end plate 13a, anode insulation plate 11, single battery cell m3, single battery cell m2, single battery cell m1, and cathode insulation plate 12 are housed in this order from the bottom side.

Next, lid-shaped end plate 14b with disc spring 14d, folder 14c, and cylinder 14a attached thereto is placed on box-shaped end plate 13a.

Next, box-shaped end plate 13a and lid-shaped end plate 14b are compressed using a press machine (not illustrated) until they make intimate contact with each other. In this compression state, box-shaped end plate 13a and lid-shaped end plate 14b are fixed using bolt 15.

It is to be noted that cylinder 14a is attached to internal space 14ba inside lid-shaped end plate 14b through seal 9d. Cylinder 14a is movable in the ±y direction (in the drawing vertical direction) in space 14ba.

Operation of Electrochemical Hydrogen Pump 23

In electrochemical hydrogen pump 23, anode insulation plate 11, single battery cell m1, single battery cell m2, single battery cell m3, and cathode insulation plate 12 receive the restoration force of disc spring 14d through cylinder 14a and folder 14c so as to be pushed against the bottom surface of box-shaped end plate 13a. As a result, inside each of single battery cell m1, single battery cell m2, and single battery cell m3, the electrode layer, the diffusion layer, and the separator on each of the anode side and the cathode side is pressed against the electrolyte membrane. Thus, the contact resistance can be suppressed at a low value.

in this state, when the pressure of the hydrogen on the cathode side increases through electrochemical reaction, a force away from the electrolyte membrane acts on the cathode separator. However, since the hydrogen on the cathode side is guided also to space 14ba, a force bringing the cathode separator closer to the electrolyte membrane acts in cylinder 14a due to the pressure of the hydrogen. Eventually, both forces will cancel each other out. Therefore, the force with which the electrode layer, diffusion layer, and separator on the anode and cathode sides, respectively, are pressed against the electrolyte membrane is maintained only by the restorative force of disc spring 14d, regardless of the magnitude of the hydrogen pressure.

Therefore, even if there is a differential pressure between the anode and cathode sides, the separator will not flex and the contact resistance will not increase.

### CITATION LIST

### Patent Literature

PTL 1

Japanese Patent Application Laid-Open No. 2006-316288

### SUMMARY OF INVENTION

### Technical Problem

However, in the configuration shown in FIG. 2, the rigidity of box-shaped end plate 13a and lid-shaped end plate 14b must be sufficiently large to suppress the deflection of the separator such that the increase of the contact resistance is sufficiently small. In other words, the deformation of the separator in the ±y direction must be made extremely small even when the hydrogen pressure is high.

In order to achieve this, the wall thickness of box-shaped end plate 13a and lid-shaped end plate 14b must be sufficiently large. Therefore, the weight of each component becomes extremely large, making it difficult to handle as a household hydrogen refueling apparatus and becoming an obstacle to cost reduction.

An object of an aspect of the present disclosure is to provide an electrochemical hydrogen pump that can achieve a lightweight and compact structure and suppress reduction of the efficiency due to increase of contact resistance.

### Solution to Problem

An electrochemical hydrogen pump according to an aspect of the present disclosure includes: at least one single battery cell including an anode separator, an anode diffusion layer, an anode electrode layer, an electrolyte membrane, a cathode electrode layer, a cathode diffusion layer, and a cathode separator; and an anode side member and a cathode side member provided to sandwich the at least one single battery cell. A pressure space is provided at a position where the anode diffusion layer and the cathode diffusion layer are sandwiched, and the pressure space includes an anode pressure space provided in the anode side member, and a cathode pressure space provided in the cathode side member.

### Advantageous Effects of Invention

According to the present disclosure, it is possible to achieve a lightweight and compact structure and suppress reduction of the efficiency due to increase of contact resistance.

### BRIEF DESCRIPTION OF DRAWINGS

FIG. 1A is a schematic sectional view including a cathode inlet/outlet of a power generation stack of a known fuel cell;

FIG. 1B is a schematic sectional view including an anode inlet/outlet of the power generation stack of the known fuel cell;

FIG. 1C illustrates an exemplary state of a part of the cross-section illustrated in FIG. 1A;

FIG. 2 is a schematic sectional view of an electrochemical hydrogen pump disclosed in PTL 1;

FIG. 3A is a schematic sectional view including a cathode manifold of an electrochemical hydrogen pump according to Embodiment 1 of the present disclosure;

FIG. 3B is a schematic sectional view including an anode manifold of the electrochemical hydrogen pump according to Embodiment 1 of the present disclosure;

FIG. 3C is a drawing illustrating each figure obtained by projecting a center line of each seal of the electrochemical hydrogen pump according to Embodiment 1 of the present disclosure on one flat surface perpendicular to the stacking direction;

FIG. 3D is a drawing illustrating each figure obtained by projecting a center line of each seal of an electrochemical hydrogen pump according to Embodiment 2 of the present disclosure on one flat surface perpendicular to the stacking direction;

FIG. 3E is a drawing illustrating each figure obtained by projecting a center line of each seal of the electrochemical hydrogen pump according to Embodiment 3 of the present disclosure on one flat surface perpendicular to the stacking direction;

FIG. 4 is a schematic sectional view including a cathode manifold of the electrochemical hydrogen pump according to Embodiment 2 of the present disclosure;

FIG. 5 is a schematic sectional view including a cathode manifold of the electrochemical hydrogen pump according to Embodiment 3 of the present disclosure;

FIG. 6 is a schematic sectional view of an evaluation apparatus of the electrochemical hydrogen pump; and

FIG. 7 illustrates results of evaluations of a known fuel cell power generation stack, the electrochemical hydrogen pump disclosed in PTL 1, and the electrochemical hydrogen pumps according to Embodiments 1 to 3 of the present disclosure, using the evaluation apparatus of the electrochemical hydrogen pump illustrated in FIG. 6.

### DESCRIPTION OF EMBODIMENTS

Embodiments of the present disclosure are described below with reference to the drawings. It is to be noted that the common components in the drawings are denoted with the same reference numerals, and the description thereof is appropriately omitted.

### Embodiment 1

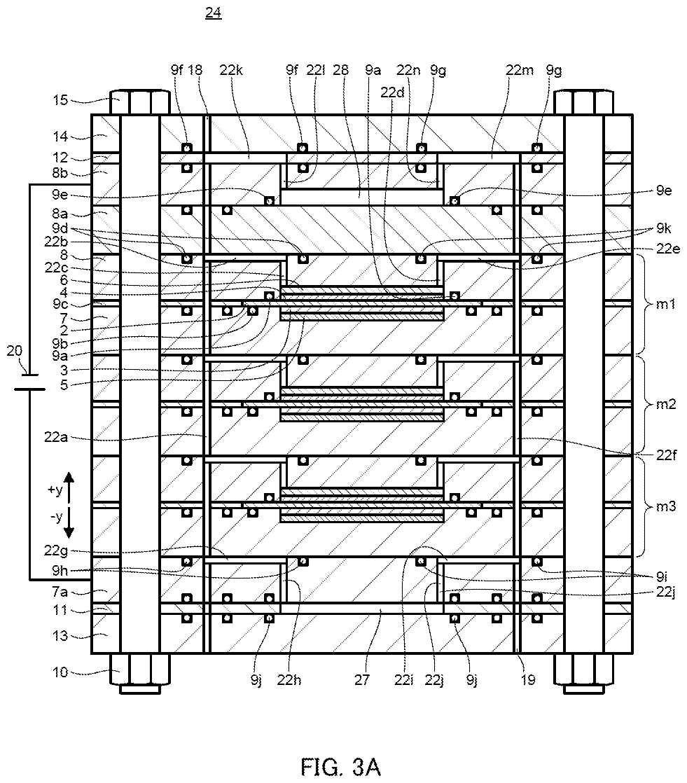

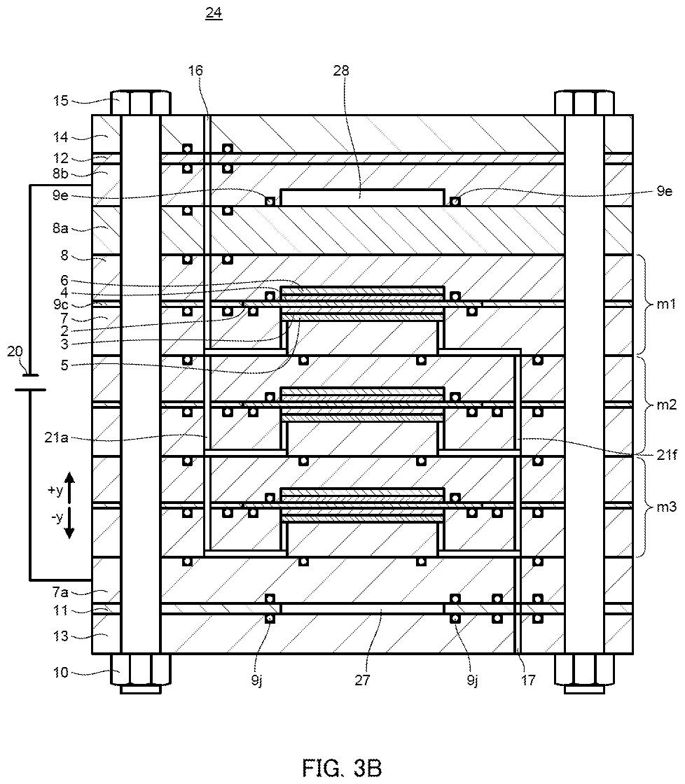

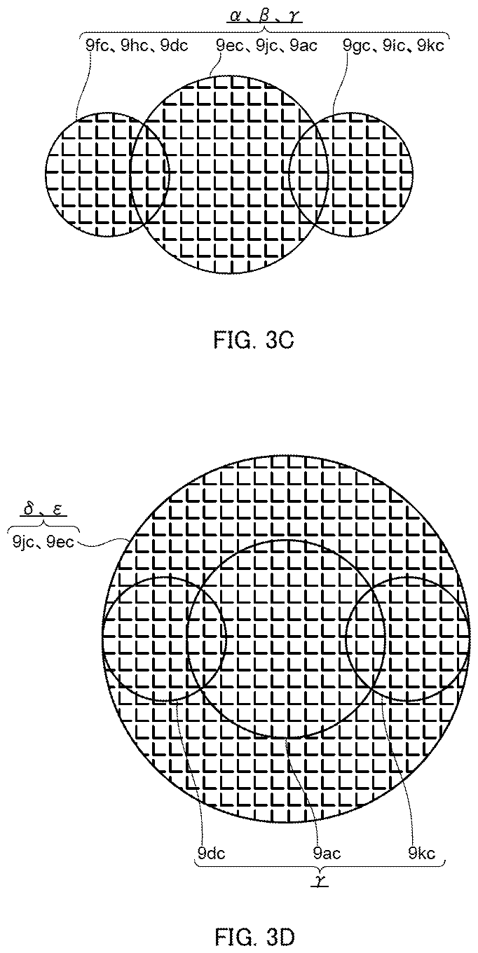

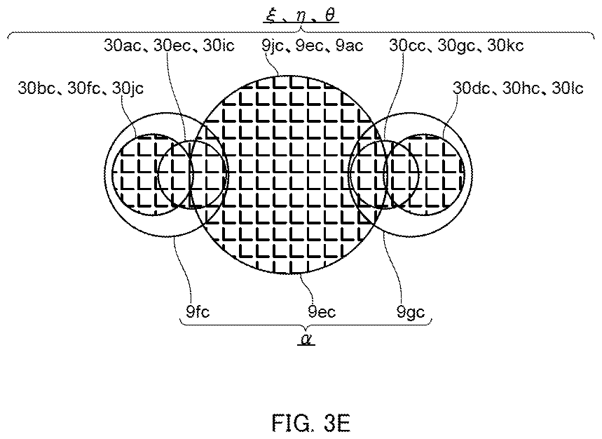

Electrochemical hydrogen pump 24 according to Embodiment 1 of the present disclosure is described below with reference to FIG. 3A and FIG. 3B. FIG. 3A is a schematic cross-sectional view including the cathode inlet/outlet of electrochemical hydrogen pump 24 of the present embodiment. FIG. 3B is a schematic sectional view including the anode inlet/outlet of electrochemical hydrogen pump 24 of the present embodiment.

### General Configuration

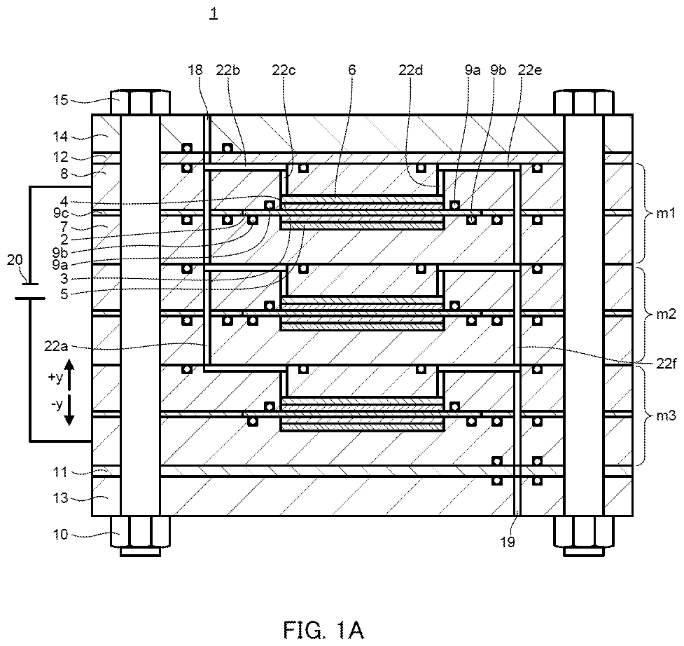

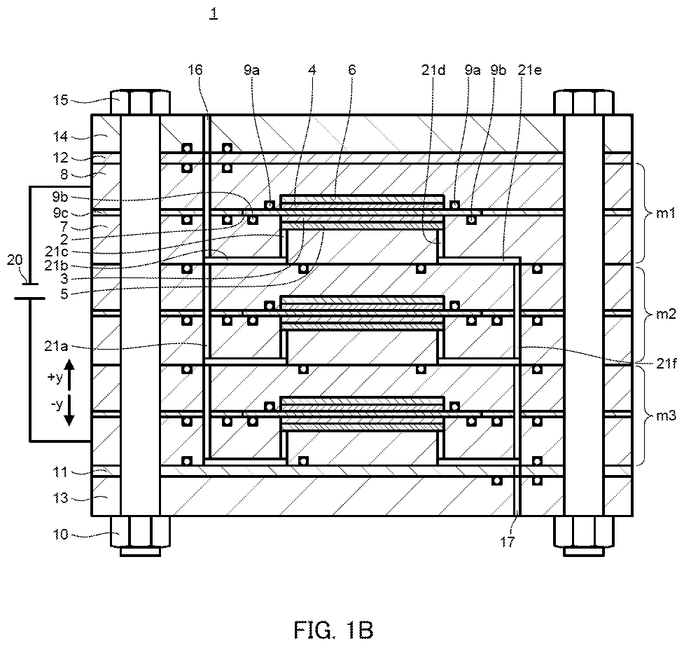

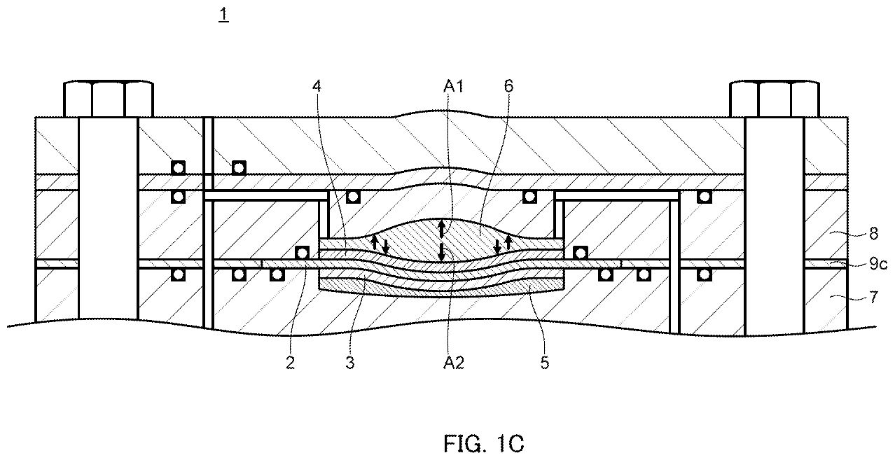

In electrochemical hydrogen pump 24 illustrated in FIG. 3A and FIG. 3B, three single battery cells m1, m2 and m3 are stacked as in power generation stack 1 illustrated in FIG. 1A and FIG. 1B.

In electrochemical hydrogen pump 24, anode end plate 13, anode insulation plate 11, A-end separator 7a, single battery cell m3, single battery cell m2, single battery cell m1, C-end separator 8a, C-pressure plate 8b, cathode insulation plate 12, and cathode end plate 14 are stacked in this order from the bottom side, and they are fastened with bolt 15 and nut 10 in the state where they are in intimate contact with each other.

Power source 20 is connected to each of A-end separator 7a and C-pressure plate 8b. A-end separator 7a and C-pressure plate 8b correspond to examples of “power source connecting member”.

Electrochemical hydrogen pump 24 differs from the above-described power generation stack 1 and electrochemical hydrogen pump 23 in that anode pressure space 27 and cathode pressure space 28 (each of which corresponds to an example of the pressure space).

Anode pressure space 27 is formed in anode insulation plate 11 (an example of the anode side member). In addition, cathode pressure space 28 is formed in C-pressure plate 8b (an example of the cathode side member).

Anode pressure space 27 is communicated with cathode inlet manifold 22a (an example of the cathode manifold) through cathode inlet horizontal introduction path 22g and cathode inlet vertical introduction path 22h. In addition, anode pressure space 27 is communicated with cathode outlet manifold 22f (an example of the cathode manifold) through cathode outlet horizontal introduction path 22i and cathode outlet vertical introduction path 22j.

Cathode pressure space 28 is communicated with cathode inlet manifold 22a through cathode inlet horizontal introduction path 22k and cathode inlet vertical introduction path 22l. In addition, cathode pressure space 28 is communicated with cathode outlet manifold 22f through cathode outlet horizontal introduction path 22m and cathode outlet vertical introduction path 22n.

It is to be noted that introduction paths 22g to 22n illustrated in FIG. 3A correspond to examples of “first introduction path”. In addition, introduction paths 22b to 22e illustrated in FIG. 3A correspond to examples of “second introduction path”.

Anode pressure space 27 and cathode pressure space 28 have a cylindrical shape whose central axis is parallel to the stacking direction (the ±y direction in the drawing, i.e., the vertical direction in the drawing).

It is to be noted that in the present embodiment, a space including a first space part (for example, anode pressure space 27) and a second space part (for example, introduction paths 22g and 22i) may be referred to as an anode pressure space. The first space part is formed to include cathode diffusion layer 6 as viewed in the stacking direction (from directly above; the same shall apply hereinafter). The second space part is communicated with the first space part and a cathode manifold (for example, cathode inlet manifold 22a and cathode outlet manifold 22f), and is formed to include the second introduction path (for example, introduction paths 22b to 22e) as viewed in the stacking direction at a position where it does not at least partly overlap the first space part as viewed in the direction perpendicular to the stacking direction.

In addition, in the present embodiment, a space including a third space part (for example, cathode pressure space 28) and a fourth space part (introduction path 22k, 22 m) may be referred to as a cathode pressure space. The third space part is formed to include cathode diffusion layer 6 as viewed in the stacking direction. The fourth space part is communicated with the third space part and the cathode manifold (for example, cathode inlet manifold 22a and cathode outlet manifold 22f), and is formed to include the second introduction path (for example, introduction paths 22b to 22e) as viewed in the stacking direction at a position where it does not at least partly overlap the third space part as viewed in the direction perpendicular to the stacking direction.

In addition, preferably, the first space part and the third space part have a shape corresponding to cathode diffusion layer 6, and the second space part and the fourth space part have a shape corresponding to a shape corresponding to the second introduction path. Their shapes are preferably a circular shape.

### Description of Each Component

Electrolyte membrane 2 is a positive ion transmission film, and for example, Nafion (registered trademark; available from DuPont de Nemours, Inc.), Aciplex (trade name; available from Asahi Kasei Corporation) and the like may be used. In the surface of electrolyte membrane 2 on the anode side, anode electrode layer 3 including RuIrFeOx catalyst is provided, for example. In the surface of electrolyte membrane 2 on the cathode side, cathode electrode layer 4 including platinum catalyst is provided, for example.

Anode diffusion layer 5 needs to be able to withstand the pressing of electrolyte membrane 2 due to the high-pressure hydrogen in cathode diffusion layer 6. Therefore, a conductive porous material such as a titanium fiber sintered material or a titanium powder sintered material with platinum plating on its surface may be used as anode diffusion layer 5.

As cathode diffusion layer 6, for example, a highly elastic graphitized carbon fiber (carbon fiber that is progressively graphitized through a processing at a high temperature of 2000° C. or higher) or a porous material provided with platinum plating on the surface of a titanium powder sintered body in a paper form may be used.

As seals 9a to 9j, anode insulation plate 11, and cathode insulation plate 12, for example, fluoro rubber obtained through compression shaping may be used.

Seals 9a, 9e and 9j have an enclosing shape (for example, an annular shape) having the same central axis as the central axis of cathode pressure space 28 (or anode pressure space 27), for example. In addition, seals 9d, 9f, 9g, 9h, 9i and 9k have an enclosing shape (for example, an annular shape) having a central axis parallel to the central axis of cathode pressure space 28 (or anode pressure space 27), for example.

As anode end plate 13, A-end separator 7a, anode separator 7, cathode separator 8, C-end separator 8a, C-pressure plate 8b, and cathode end plate 14 may be a plate of SUS316L cut and worked into a shape with a space for housing the diffusion layer and the like, for example.

### Pressure Space

Seal 9e surrounds cathode pressure space 28.

Seal 9f surrounds cathode inlet horizontal introduction path 22k and cathode inlet vertical introduction path 22l that communicate between cathode inlet manifold 22a and cathode pressure space 28.

Seal 9g surrounds cathode outlet horizontal introduction path 22m and cathode outlet vertical introduction path 22n that communicate between cathode outlet manifold 22f and cathode pressure space 28.

Here, the center lines of seal 9e, 9f and 9g are referred to as 9ec, 9fc and 9gc. In this case, figure α illustrated in FIG. 3C is a figure obtained by projecting 9ec, 9fc and 9gc on one flat surface perpendicular to the stacking direction i.e., the ±y direction (the vertical direction in the drawing; the same shall apply hereinafter).

Seal 9j surrounds anode pressure space 27.

Seal 9h surrounds cathode inlet horizontal introduction path 22g and cathode inlet vertical introduction path 22h that communicate between cathode inlet manifold 22a and anode pressure space 27.

Seal 9i surrounds cathode outlet horizontal introduction path 22i and cathode outlet vertical introduction path 22j that communicate between cathode outlet manifold 22f and anode pressure space 27.

Here, the center lines of seals 9h, 9j and 9i are referred to as 9hc, 9jc and 9ic. In this case, figure β illustrated in FIG. 3C is a figure obtained by projecting 9hc, 9jc and 9ic on one flat surface perpendicular to the stacking direction, i.e., the ±y direction. This figure β is congruent with figure α.

Seal 9a surrounds cathode diffusion layer 6.

Seal 9d surrounds cathode inlet horizontal introduction path 22b and cathode inlet vertical introduction path 22c that communicate between cathode inlet manifold 22a and cathode diffusion layer 6.

Seal 9k surrounds cathode outlet horizontal introduction path 22e and cathode outlet vertical introduction path 22d that communicate between cathode outlet manifold 22f and cathode diffusion layer 6.

Here, the center lines of seals 9a, 9d and 9k are referred to as 9ac, 9dc and 9kc. In this case, figure γ illustrated in FIG. 3C is a figure obtained by projecting 9ac, 9dc and 9kc on one flat surface perpendicular to the stacking direction, i.e., the ±y direction. This figure γ is congruent with figures α and β.

Figures α and β correspond to examples of “first figure”. In addition, figure γ corresponds to an example of “second figure”.

It is to be noted that an example in which figures α, β and γ are congruent with each other is described above, but this is not limitative. For example, the area of at least one of figures α, β and γ may be larger than the areas of other figures. That is, it suffices that each seal illustrated in FIG. 3A has an area that can surround the object (for example, anode pressure space 27, cathode pressure space 28, cathode electrode layer 6, and the introduction paths), and it is not necessary that all seals have the same area.

### Operational Effect of Pressure Space

As with the case where power generation stack 1 illustrated in FIG. 1A and FIG. 1B is used as a hydrogen pump, when a current is supplied to power source 20 in the state where low pressure hydrogen flows from anode inlet 16 illustrated in FIG. 3B toward anode outlet 17, hydrogen gas is generated in cathode diffusion layer 6 by electrochemical reaction. At this time, when cathode inlet 18 and cathode outlet 19 illustrated in FIG. 3A are closed and stopped, the hydrogen on the anode side moves to the cathode side in proportion to the applied current even with a constant hydrogen volume. Thus, the pressure of the hydrogen in cathode diffusion layer 6 gradually increases. With the increase of the pressure, cathode separator 8 is pushed to the +Y direction, and anode separator 7 is pushed to the −Y direction through electrolyte membrane 2 and anode diffusion layer 5.

Here, the hydrogen at high pressure is guided also to cathode pressure space 28 and anode pressure space 27.

Thus, for example, through C-pressure plate 8b and cathode-end separator 8a, cathode separator 8 of single battery cell m1 receives the force of the −y direction (the product of the hydrogen pressure and the area of figure α) due to the high-pressure hydrogen in cathode pressure space 28, cathode inlet horizontal introduction path 22k, cathode inlet vertical introduction path 22l, cathode outlet horizontal introduction path 22m, and cathode outlet vertical introduction path 22n.

Meanwhile, cathode separator 8 of single battery cell m1 receives the force of the +Y direction (the product of the hydrogen pressure and the area of figure γ) due to the high-pressure hydrogen in cathode diffusion layer 6, cathode inlet horizontal introduction path 22b, cathode inlet vertical introduction path 22c, cathode outlet horizontal introduction path 22e, and cathode outlet vertical introduction path 22d.

Here, the force of the −y direction and the force of the +Y direction cancel each other out, and therefore the force exerted on cathode separator 8 of single battery cell m1 is very small. As a result, the deflection of cathode separator 8 is very small.

Likewise, the force of the hydrogen in cathode diffusion layer 6 of single battery cell m1, the force of the hydrogen in cathode diffusion layer 6 of single battery cell m2, the force of the hydrogen in cathode diffusion layer 6 of single battery cell m3, and the force of the hydrogen in anode pressure space 27 and the like cancel each other out. Thus, the force exerted on cathode separator 8 and anode separator 7 is very small, and therefore their deflection is very small. It is to be noted that “the force of the hydrogen in anode pressure space 27 and the like” refers to the force (the product of the hydrogen pressure and the area of β) of the hydrogen in anode pressure space 27, cathode inlet horizontal introduction path 22g, cathode inlet vertical introduction path 22h, cathode outlet horizontal introduction path 22i, and cathode outlet vertical introduction path 22j.

As described above, in electrochemical hydrogen pump 24, the expansion of the space where cathode diffusion layer 6 is housed in the stacking direction (the ±y direction) can be suppressed. Thus, it is possible to suppress the increase of the contact resistance due to reduction of the contact pressure between cathode diffusion layer 6 and cathode separator 8, and the contact pressure between cathode diffusion layer 6 and cathode electrode layer 4.

### Evaluation Apparatus

Evaluation apparatus 31 of electrochemical hydrogen pump 24 is described below with reference to FIG. 6. FIG. 6 is a schematic sectional view of evaluation apparatus 31 of electrochemical hydrogen pump 24.

As illustrated in FIG. 6, evaluation apparatus 31 includes power source 20, hydrogen cylinder 32, valve 45 thereof, regulator 33, bubbler 34, heater 35, gas-liquid separation apparatus 36, cooling apparatus 37, pressure gauge 38, exhaust valve 39, nitrogen cylinder 40, valve 44 thereof, dilution apparatus 41, exhaust port 42, and three-way valve 43.

Evaluation apparatus 31 supplies a current from power source 20 to electrochemical hydrogen pump 24, and supplies low pressure hydrogen to electrochemical hydrogen pump 24 through the use of hydrogen cylinder 32 and regulator 33. This low pressure hydrogen is humidified by bubbler 34 and heater 35.

The dew point of the excess hydrogen that is not used in electrochemical hydrogen pump 24 is reduced by gas-liquid separation apparatus 36 and cooling apparatus 37.

In addition, on the high pressure side, the hydrogen pressure is measured with pressure gauge 38. Basically, exhaust valve 39 downstream of pressure gauge 38 is in closed state, and is opened when the hydrogen pressure becomes a predetermined value or greater.

It should be noted that the opening level of exhaust valve 39 is adjusted such that a sufficient pressure drop is generated. Specifically, the opening level of exhaust valve 39 is adjusted such that the pressure of the hydrogen past exhaust valve 39 is reduced to a pressure substantially equal to the atmosphere pressure (about 1.05 times the atmosphere pressure) with the pressure drop generated at exhaust valve 39.

The dew point of the hydrogen that is depressurized to a pressure substantially equal to the atmosphere pressure is reduced by gas-liquid separation apparatus 36 and cooling apparatus 37. Thereafter, the hydrogen is diluted inside dilution apparatus 41 by nitrogen supplied from nitrogen cylinder 40, and is then discharged to the exterior of exhaust port 42 and the like.

### Evaluation Process

The following describes evaluation processes (1) to (9) for evaluation of electrochemical hydrogen pump 24 through the use of evaluation apparatus 31. It is to be noted that in the following description, heater 35 is set at 65° C., and cooling apparatus 37 is set at 20° C., as an example.

(1) As illustrated in FIG. 6, electrochemical hydrogen pump 24 is connected to evaluation apparatus 31.

(2) Three-way valve 43 is switched from the atmosphere open side (arrow A) to the sealing side (arrow B).

(3) Nitrogen is supplied from nitrogen cylinder 40 to dilution apparatus 41 by operating valve 44 of nitrogen cylinder 40.

(4) Low-pressure (pressure ratio 0.05) is supplied to hydrogen electrochemical hydrogen pump 24 by operating valve 45 of hydrogen cylinder 32 and regulator 33.

(5) Power source 20 is turned ON and the current value is set to 1.0 (A/cm²) through calculation based on the electrode area.

(6) In the period until pressure gauge 38 reaches a target pressure (pressure ratio 100), the voltage and current displayed on power source 20 are recorded each time the pressure ratio increases by 10.0. The resistance is calculated based on the recorded current and voltage.

(7) Supply of hydrogen is stopped by turning OFF power source 20 and operating valve 45, and then supply of the nitrogen is stopped by operating valve 44.

(8) Three-way valve 43 is switched from the sealing side (arrow B) to the atmosphere open side (arrow A).

(9) Electrochemical hydrogen pump 24 is detached from evaluation apparatus 31.

### Evaluation Results

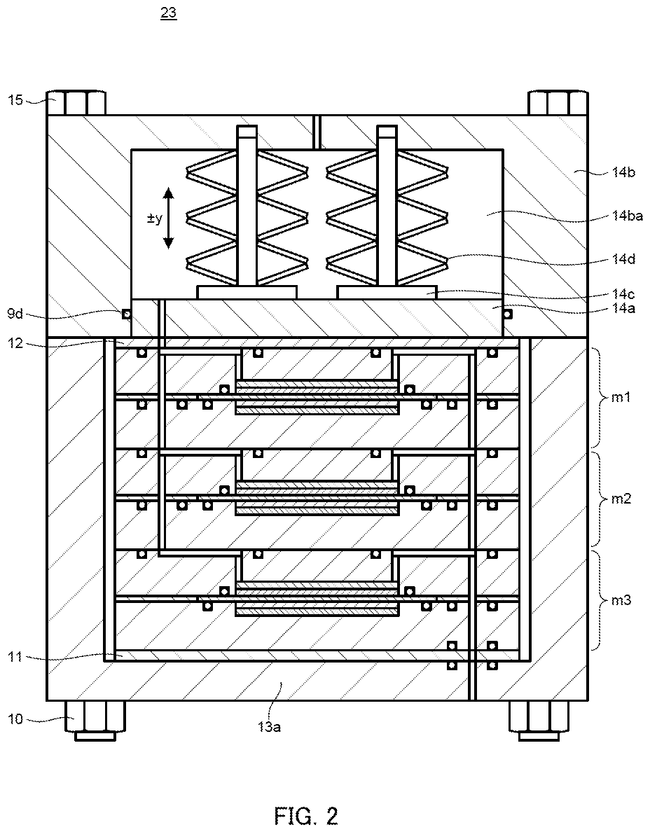

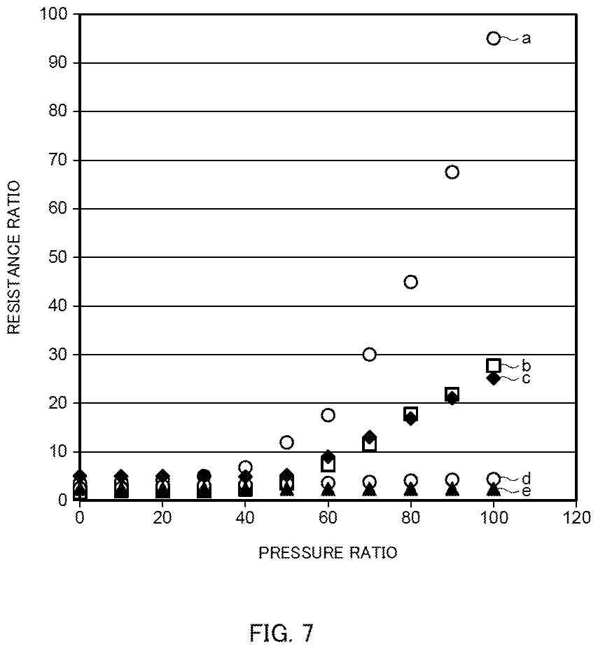

Through the use of power generation stack 1 (see FIG. 1A and FIG. 1B) as a hydrogen pump, the above-described evaluation processes were performed. In addition, the above-described evaluation processes were performed also with electrochemical hydrogen pump 23 disclosed in PTL 1 (see FIG. 2). Evaluation results of electrochemical hydrogen pump 24, power generation stack 1, and electrochemical hydrogen pump 23 are illustrated in FIG. 7. In FIG. 7, the abscissa indicates the pressure ratio, and the ordinate indicates the resistance ratio.

In FIG. 7, each circular plot a indicates the pressure ratio and the resistance ratio obtained through the above-mentioned evaluation processes performed on power generation stack 1. In addition, each quadrangular plot b indicates the pressure ratio and the resistance ratio obtained through the above-mentioned evaluation processes performed on electrochemical hydrogen pump 24. In addition, each triangular plot e indicates the pressure ratio and the resistance ratio obtained through the above-mentioned evaluation processes performed on electrochemical hydrogen pump 23.

It is to be noted that each circular plot d will be described in Embodiment 2, and each rhombus plot c will be described in Embodiment 3.

In each plot a indicating evaluation results of power generation stack 1, the resistance ratio increases as the pressure ratio increases. A possible reason for this is that with the pressure of the hydrogen in cathode diffusion layer 6 of each of single battery cells m1, m2 and m3, cathode separator 8 and anode separator 7 were deflected, the space where cathode diffusion layer 6 is housed was expanded in the stacking direction (the ±y direction), the contact pressure between cathode diffusion layer 6 and cathode separator 8 and the contact pressure between cathode diffusion layer 6 and anode electrode layer 4 were reduced, and thus the contact resistance was increased.

On the other hand, in each plot e indicating evaluation results of electrochemical hydrogen pump 23, the resistance ratio does not increase at all even when the pressure ratio increases. A possible reason for this is that the force of the pressure of the hydrogen in cathode diffusion layer 6 and the force of the hydrogen pressure in pressure space 14ba (see FIG. 2) canceled each other out, and box-shaped end plate 13a and lid-shaped end plate 14b did not deform at all even when with a high hydrogen pressure in pressure space 14ba.

In order for box-shaped end plate 13a and lid-shaped end plate 14b not to deform at all, it is necessary to significantly increase the rigidity of box-shaped end plate 13a and lid-shaped end plate 14b, and it is necessary to increase the thickness of each component. In the case where all single battery cells m1, m2 and m3 illustrated in FIG. 1A, FIG. 1B and FIG. 2 were set to have the same thickness, the weight of electrochemical hydrogen pump 23 was approximately 2.5 times power generation stack 1. As such, electrochemical hydrogen pump 23 is too heavy to be used as a household hydrogen pump and is difficult to handle.

In comparison with plots a and e, in each plot b indicating evaluation results of electrochemical hydrogen pump 24, the resistance ratio increases as the pressure ratio increases, but the increase of the resistance ratio is suppressed to approximately one-third of each plot a.

The reason that the increase of the resistance was suppressed in the above-mentioned manner is that the force of the pressure of the hydrogen in cathode diffusion layer 6 and the force of the hydrogen pressure in cathode pressure space 28 and anode pressure space 27 canceled each other out, thus suppressing the deflection of cathode separator 8 and anode separator 7.

On the other hand, in each plot b, the increase of the resistance is large in comparison with each plot e. A possible reason for this is that deflection of cathode end plate 14 to the +Y direction and deflection of anode end plate 13 to the −Y direction were slightly generated, the deflections were spread to the separators, and the housing space of cathode diffusion layer 6 was slightly expanded. Specifically, a possible reason is that the contact pressure between cathode diffusion layer 6 and cathode separator 8, and the contact pressure between cathode diffusion layer 6 and cathode electrode layer 4 were reduced, and the contact resistance was slightly increased.

However, in the case where single battery cells m1, m2 and m3 illustrated in FIG. 1A, FIG. 1B, FIG. 3A and FIG. 3B were set to have the same size, the weight of electrochemical hydrogen pump 24 was approximately 1.1 times the weight of power generation stack 1. That is, the weight of electrochemical hydrogen pump 24 was no problem in handling it as a household hydrogen pump.

Accordingly, electrochemical hydrogen pump 24 of the present embodiment is suitable for household use when the specification allows for the increase of the resistance indicated by each plot b.

In electrochemical hydrogen pump 24 of the present embodiment, high-pressure hydrogen generated at cathode diffusion layer 6 of single battery cell m1 to m3 is guided to anode pressure space 27 and cathode pressure space 28. Accordingly, even when pushed by the pressure of the hydrogen in cathode diffusion layer 6, anode separator 7 and cathode separator 8 are pushed back by the pressure of the hydrogen in anode pressure space 27 and cathode pressure space 28. Thus, anode separator 7 and cathode separator 8 can suppress the deflection to a significantly small level. Accordingly, expansion of the space where cathode diffusion layer 6 is housed in the stacking direction can be suppressed, and therefore the increase of the contact resistance can be suppressed. As a result, it is possible to suppress a situation where boosting of a certain amount of hydrogen requires a higher voltage and consequently the efficiency as an electrochemical hydrogen pump is reduced.

In addition, electrochemical hydrogen pump 24 of the present embodiment does not require a highly rigid member (for example, box-shaped end plate 13a and lid-shaped end plate 14b illustrated in FIG. 2 and the like), and thus can achieve a lightweight and compact structure. Thus, it is easy to handle with no obstacle to cost reduction.

In addition, in electrochemical hydrogen pump 24 of the present embodiment, anode pressure space 27 includes the first space part and the second space part, and cathode pressure space 28 includes the third space part and the fourth space part. Thus, the total area of the space parts can be reduced, and the resistance ratio can be suppressed at a sufficient level for a pump performance.

### Embodiment 2

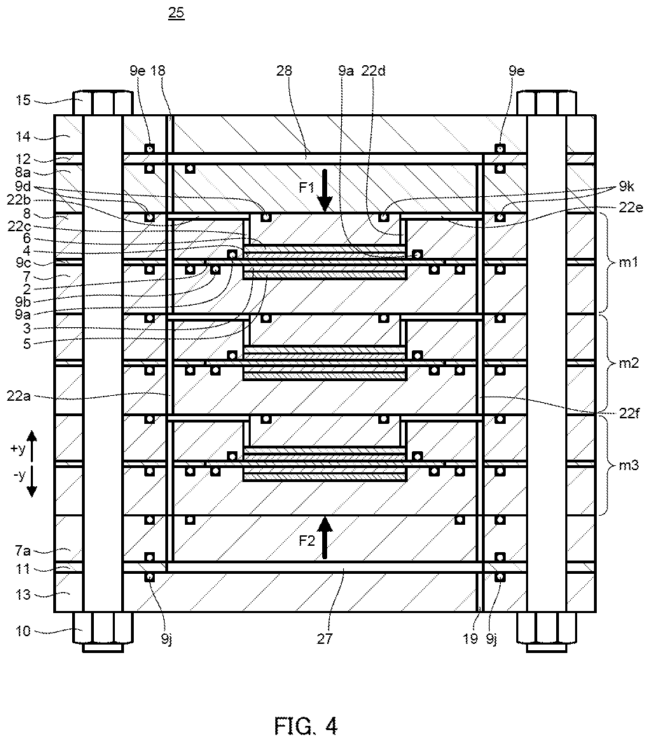

Electrochemical hydrogen pump 25 according to Embodiment 2 of the present disclosure is described below with reference to FIG. 4. FIG. 4 is a schematic cross-sectional view including a cathode inlet/outlet of electrochemical hydrogen pump 25 of the present embodiment.

### General Configuration

In electrochemical hydrogen pump 25, anode end plate 13, anode insulation plate 11, A-end separator 7a, single battery cell m3, single battery cell m2, single battery cell m1, C-end separator 8a, cathode insulation plate 12, and cathode end plate 14 are stacked in this order from the bottom side, and they are fastened with bolt 15 and nut 10 in the state where they are in intimate contact with each other.

Anode pressure space 27 is formed in anode insulation plate 11 (an example of the anode side member). In addition, cathode pressure space 28 is formed in cathode insulation plate 12 (an example of the cathode side member).

Anode pressure space 27 is communicated with cathode inlet manifold 22a and cathode outlet manifold 22f. Also, cathode pressure space 28 is communicated with cathode inlet manifold 22a and cathode outlet manifold 22f.

Although illustration is omitted in FIG. 4, power source 20 is connected to A-end separator 7a and C-end separator 8a, for example. A-end separator 7a and C-end separator 8a correspond to examples of “power source connecting member”.

### Pressure Space

Seal 9j surrounds anode pressure space 27. Here, assuming the center line of seal 9j to be 9jc, figure δ illustrated in FIG. 3D is a figure obtained by projecting 9jc on one flat surface perpendicular to the stacking direction, i.e., the ±y direction.

Seal 9e surrounds cathode pressure space 28. Here, assuming the center line of seal 9e to be 9ec, figure ε illustrated in FIG. 3D is a figure obtained by projecting 9ec on one flat surface perpendicular to the stacking direction, i.e., the ±y direction. Figure ε is congruent with figure δ.

In FIG. 3D, figure γ described in Embodiment 1 is illustrated in an overlapping manner. Figure γ is a figure obtained by projecting the center lines 9ac, 9dc and 9kc of seals 9a, 9d, and 9k on one flat surface perpendicular to the stacking direction, i.e., the ±y direction as described above.

figures δ and ε correspond to examples of “third figure”. In addition, figure γ illustrated in FIG. 3D corresponds to an example of “fourth figure”.

### Operational Effect of Pressure Space

As seen from FIG. 3D, the area of each of figure δ and figure ε is larger than the area of figure γ. In addition, figure δ and figure ε include figure γ. Accordingly, the force of the hydrogen in cathode pressure space 28 pushing cathode separator 8 in the −Y direction through C-end separator 8a is greater than the force of the hydrogen in cathode diffusion layer 6 pushing cathode separator 8 in the +Y direction. Thus, cathode separator 8 of single battery cell m1 receives force F1 that presses it in the −Y direction.

On the other hand, the force of the hydrogen in anode pressure space 27 pushing anode separator 7 in the +Y direction through A-end separator 7a is greater than the force of the hydrogen in cathode diffusion layer 6 pushing anode separator 7 in the −Y direction through electrolyte membrane 2. Thus, cathode separator 8 of single battery cell m3 receives force F2 that presses it in the +Y direction. Here, F1 and F2 have the same value in opposite directions.

### Evaluation Results

FIG. 7 shows results obtained through the evaluation process described in Embodiment 1 performed on electrochemical hydrogen pump 25 of the present embodiment. In FIG. 7, each circular plot d indicates the pressure ratio and the resistance ratio obtained through the above-mentioned evaluation processes performed on electrochemical hydrogen pump 25.

In FIG. 7, each plot d is almost the same as each plot e indicating the evaluation result of electrochemical hydrogen pump 23 disclosed in PTL 1. Thus, it is seen that in electrochemical hydrogen pump 25 of the present embodiment, the deflection of cathode separator 8 and anode separator 7 is suppressed to the same level as that of electrochemical hydrogen pump 23 disclosed in PTL 1. A possible reason for this is that as illustrated in FIG. 4, forces F1 and F2 act in a direction of compressing single battery cells m1, m2 and m3.

However, as can be seen from FIG. 3D, the area of each of figure δ and figure ε is greater than the area of figure γ. Thus, in electrochemical hydrogen pump 25, the force of separating cathode end plate 14 from C-end separator 8a in the +Y direction, or the force of separating anode end plate 13 from A-end separator 7a in the −y direction is greater in comparison with electrochemical hydrogen pump 24 of Embodiment 1. Therefore, electrochemical hydrogen pump 25 required a fastening force of bolt 15 that is 1.7 times that of electrochemical hydrogen pump 24. The thickness was modified in accordance with the above-mentioned fastening force so as to maintain the strength of each component, and as a result, the weight of electrochemical hydrogen pump 25 was 1.8 times the weight of electrochemical hydrogen pump 24.

Accordingly, while the weight of electrochemical hydrogen pump 25 is almost twice that of electrochemical hydrogen pump 24, an effect of suppressing the increase of the resistance was achieved.

### Embodiment 3

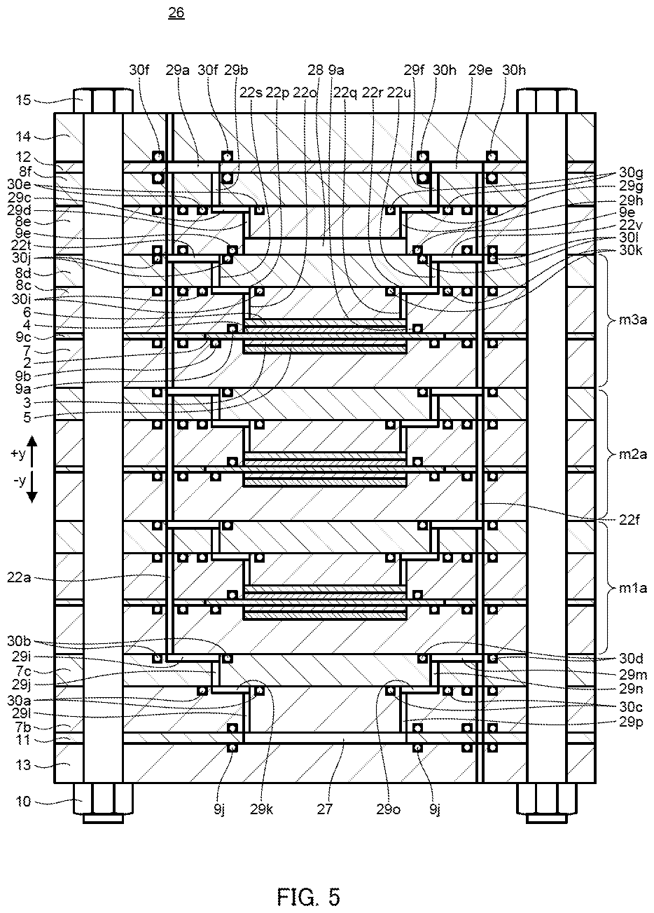

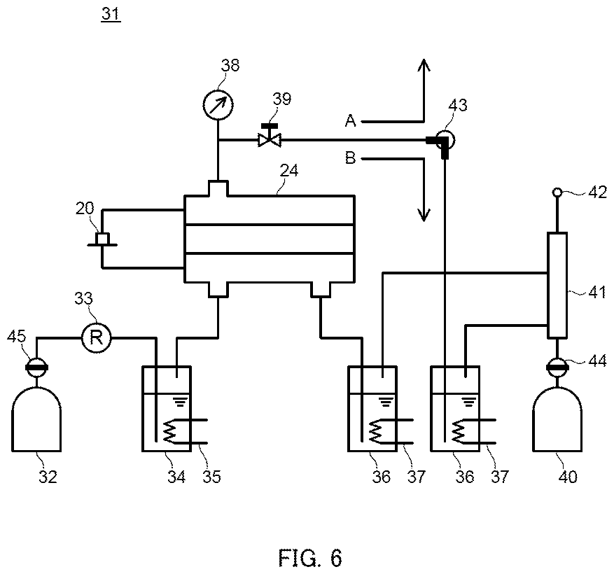

Electrochemical hydrogen pump 26 according to Embodiment 3 of the present disclosure is described below with reference to FIG. 5. FIG. 5 is a schematic cross-sectional view of a cathode inlet/outlet of electrochemical hydrogen pump 26 of the present embodiment.

### General Configuration

In electrochemical hydrogen pump 26 illustrated in FIG. 5, three single battery cells m1a, m2a and m3a are stacked.

Configurations of single battery cells m1a, m2a and m3a are described below.

Each of single battery cells m1a, m2a and m3a includes anode separator 7, anode diffusion layer 5, anode electrode layer 3, electrolyte membrane 2, seal 9c, cathode electrode layer 4, and cathode diffusion layer 6. These components are the same as those of electrochemical hydrogen pump 25 of Embodiment 1.

In the present embodiment, each of single battery cells m1a, m2a and m3a includes first cathode separator 8c and second cathode separator 8d in place of cathode separator 8 described in Embodiment 1.

First cathode separator 8c is provided with cathode inlet vertical introduction path 22o and cathode inlet horizontal introduction path 22p, which are communicated with the housing part of cathode diffusion layer 6 on the inlet side. In addition, first cathode separator 8c is provided with cathode outlet vertical introduction path 22q and cathode outlet horizontal introduction path 22r, which are communicated with the housing part of cathode diffusion layer 6 on the outlet side.

Second cathode separator 8d is provided with cathode inlet vertical introduction path 22s and cathode inlet horizontal introduction path 22t, which are communicated with cathode inlet manifold 22a on the inlet side. In addition, second cathode separator 8d is provided with cathode outlet vertical introduction path 22u and cathode outlet horizontal introduction path 22v, which are communicated with cathode outlet manifold 22f on the outlet side.

Thus, cathode inlet manifold 22a is communicated with the housing part of cathode diffusion layer 6 (inlet side), and cathode outlet manifold 22f is communicated with the housing part of cathode diffusion layer 6 (outlet side).

Hereinabove, configurations of single battery cells m1a, m2a and m3a are described.

As illustrated in FIG. 5, in electrochemical hydrogen pump 26, anode end plate 13, anode insulation plate 11, first A-end separator 7b, second A-end separator 7c, single battery cells m1a, m2a and m3a, first C-end separator 8e, second C-end separator 8f, cathode insulation plate 12, and cathode end plate 14 are stacked in this order from the bottom side, and they are fastened with bolt 15 and nut 10.

In first A-end separator 7b, cathode inlet horizontal introduction path 29k and cathode inlet vertical introduction path 29l are formed. In addition, in first A-end separator 7b, cathode outlet horizontal introduction path 29o and cathode outlet vertical introduction path 29p are formed.

In second A-end separator 7c, cathode inlet horizontal introduction path 29i and cathode inlet vertical introduction path 29j are formed. In addition, in second A-end separator 7c, cathode outlet horizontal introduction path 29m and cathode outlet vertical introduction path 29n are formed.

In first C-end separator 8e, cathode inlet horizontal introduction path 29c and cathode inlet vertical introduction path 29d are formed. In addition, in first C-end separator 8e, cathode outlet horizontal introduction path 29g and cathode outlet vertical introduction path 29h are formed.

In second C-end separator 8f, cathode inlet horizontal introduction path 29a and cathode inlet vertical introduction path 29b are formed. In addition, in second C-end separator 8f, cathode outlet horizontal introduction path 29e and cathode outlet vertical introduction path 29f are formed.

In anode insulation plate 11 (an example of the anode side member), anode pressure space 27 is formed. In addition, in first C-end separator 8e (an example of the cathode side member), cathode pressure space 28 is formed.

Cathode inlet manifold 22a is communicated with cathode pressure space 28 through cathode inlet horizontal introduction path 29a, cathode inlet vertical introduction path 29b, cathode inlet horizontal introduction path 29c, and cathode inlet vertical introduction path 29d.

In addition, cathode inlet manifold 22a is communicated with anode pressure space 27 through cathode inlet horizontal introduction path 29i, cathode inlet vertical introduction path 29j, cathode inlet horizontal introduction path 29k, and cathode inlet vertical introduction path 29l.

Cathode outlet manifold 22f is communicated with cathode pressure space 28 through cathode outlet horizontal introduction path 29e, cathode outlet vertical introduction path 29f, cathode outlet horizontal introduction path 29g, and cathode outlet vertical introduction path 29h.

In addition, cathode outlet manifold 22f is communicated with anode pressure space 27 through cathode outlet horizontal introduction path 29m, cathode outlet vertical introduction path 29n, cathode outlet horizontal introduction path 29o, and cathode outlet vertical introduction path 29p.

In addition, seals 30a to 30l have an enclosing shape (for example, an annular shape) having a central axis parallel to the central axis of cathode pressure space 28 (or anode pressure space 27), for example.

It is to be noted that introduction paths 29a to 29p illustrated in FIG. 5 correspond to examples of “first introduction path” that communicate between the cathode manifold and the pressure space. In addition, introduction paths 22o to 22v illustrated in FIG. 5 correspond to examples of “the second introduction path”.

In addition, although illustration is omitted in FIG. 5, power source 20 is connected to first A-end separator 7b and second C-end separator 8f, for example. First A-end separator 7b and second C-end separator 8f correspond to examples of “power source connecting member”.

It is to be noted that in the present embodiment, the space including the first space part (for example, anode pressure space 27), the second space part (for example, introduction paths 22k and 22o), and a fifth space part (for example, introduction paths 22i and 22 m) may be referred to as an anode pressure space. The first space part is formed to include cathode diffusion layer 6 as viewed in the stacking direction. The second space part is communicated with the first space part and is formed to include a part of the second introduction path (for example, introduction paths 22s, 22p, 22o, 22q, 22r and 22u) as viewed in the stacking direction at a position where it does not at least partly overlap the first space part as viewed in the direction perpendicular to the stacking direction. The fifth space part is communicated with the second space part and the cathode manifold (for example, cathode inlet manifold 22a and cathode outlet manifold 22f) and is formed to include a part of the second introduction path (for example, introduction paths 22s, 22t, 22u and 22v) as viewed in the stacking direction at a position where it does not at least partly overlap the second space part as viewed in the direction perpendicular to the stacking direction.

In addition, in the present embodiment, the space including the third space part (for example, cathode pressure space 28), the fourth space part (for example, introduction paths 29c and 29g), and a sixth space part (for example, introduction paths 29a and 29e) may be referred to as a cathode pressure space. The third space part is formed to include cathode diffusion layer 6 as viewed in the stacking direction. The fourth space part is communicated with the third space part and is formed to include a part of the second introduction path (for example, introduction paths 22s, 22p, 22o, 22q, 22r and 22u) as viewed in the stacking direction at a position where it does not at least partly overlap the third space part as viewed in the direction perpendicular to the stacking direction. The sixth space part is communicated with the fourth space part and the cathode manifold and is formed to include a part of the second introduction path (for example, introduction paths 22s, 22t, 22u and 22v) as viewed in the stacking direction at a position where it does not at least partly overlap the fourth space part as viewed in the direction perpendicular to the stacking direction.

In addition, as viewed in the stacking direction, the entirety of the second introduction path is included in at least one of the second space part and the fifth space part. In addition, as viewed in the stacking direction, the entirety of the second introduction path is included in at least one of the fourth space part and the sixth space part.

In addition, preferably the first space part and the third space part have a shape corresponding to cathode diffusion layer 6, the second space part and the fourth space part have a shape corresponding to the second introduction path, and the fifth space part and the sixth space part have a shape corresponding to the first introduction path. Their shapes are preferably a circular shape.

### Pressure Space

Seal 9j surrounds anode pressure space 27.

Seal 30a surrounds cathode inlet horizontal introduction path 29k and cathode inlet vertical introduction path 29l.

Seal 30b surrounds cathode inlet horizontal introduction path 29i and cathode inlet vertical introduction path 29j.

Seal 30c surrounds cathode outlet horizontal introduction path 29o and cathode outlet vertical introduction path 29p.

Seal 30d surrounds cathode outlet horizontal introduction path 29m and cathode outlet vertical introduction path 29n.

Here, the center lines of seal 9j, 30a, 30b, 30c and 30d are referred to as 9jc, 30ac, 30bc, 30cc and 30dc, respectively. In this case, figure illustrated in FIG. 3E is a figure obtained by projecting 9jc, 30ac, 30bc, 30cc and 30dc on one flat surface perpendicular to the stacking direction, i.e., the ±y direction.

Seal 9e surrounds cathode pressure space 28.

Seal 30e surrounds cathode inlet horizontal introduction path 29c and cathode inlet vertical introduction path 29d.

Seal 30f surrounds cathode inlet horizontal introduction path 29a and cathode inlet vertical introduction path 29b.

Seal 30g surrounds cathode outlet horizontal introduction path 29g and cathode outlet vertical introduction path 29h.

Seal 30h surrounds cathode outlet horizontal introduction path 29e and cathode outlet vertical introduction path 29f.

Here, the center lines of seal 9e, 30e, 30f, 30g and 30h are referred to as 9ec, 30ec, 30fc, 30gc and 30hc, respectively. In this case, figure η illustrated in FIG. 3E is a figure obtained by projecting 9ec, 30ec, 30fc, 30gc and 30hc on one flat surface perpendicular to the stacking direction, i.e., the ±y direction.

Seal 9a surrounds cathode diffusion layer 6.

Seal 30i surrounds cathode inlet horizontal introduction path 22p and cathode inlet vertical introduction path 22o.

Seal 30j surrounds cathode inlet horizontal introduction path 22t and cathode inlet vertical introduction path 22s.

Seal 30k surrounds cathode outlet horizontal introduction path 22r and cathode outlet vertical introduction path 22q.

Seal 30l surrounds cathode outlet horizontal introduction path 22v and cathode outlet vertical introduction path 22u.

Here, the center lines of seal 9a, 30i, 30j, 30k and 30l are referred to as 9ac, 30ic, 30jc, 30kc and 30lc, respectively. In this case, figure θ illustrated in FIG. 3E is a figure obtained by projecting 9ac, 30ic, 30jc, 30kc and 30lc on one flat surface perpendicular to the stacking direction, i.e., the ±y direction.

In FIG. 3E, figure α described in Embodiment 1 is illustrated in an overlapping manner. Figure α is a figure obtained by projecting the center lines 9ec, 9fc and 9gc of seals 9e, 9f and 9g on one flat surface perpendicular to the stacking direction, i.e., the ±y direction as described above.

Figures ξ, η and θ correspond to examples of “fifth figure”. In addition, figure α illustrated in FIG. 3E corresponds to an example of “sixth figure”.

### Operational Effect of Pressure Space

Figure ξ, figure η and figure θ illustrated in FIG. 3E are congruent. Accordingly, the force, of the high-pressure hydrogen in cathode diffusion layer 6 of single battery cell m3a, pushing up second cathode separator 8d through first cathode separator 8c in the +Y direction and the force of the high-pressure hydrogen in cathode pressure space 28 pushing down second cathode separator 8d in the −Y direction have the same value in opposite directions.

In addition, the force of the high-pressure hydrogen in cathode diffusion layer 6 pushing down anode separator 7 through electrolyte membrane 2 in the −Y direction and the force of the high-pressure hydrogen in anode pressure space 27 pushing up anode separator 7 in the +Y direction through first A-end separator 7b and second A-end separator 7c have the same value in opposite directions.

### Evaluation Results

FIG. 7 shows results obtained through the evaluation process described in Embodiment 1 performed on electrochemical hydrogen pump 26 of the present embodiment. In FIG. 7, each rhombus plot c indicates the pressure ratio and the resistance ratio obtained through the above-mentioned evaluation processes performed on electrochemical hydrogen pump 26.

In FIG. 7, each plot c is almost the same as each plot b indicating the evaluation result of electrochemical hydrogen pump 24 of Embodiment 1. Thus, it is seen that in electrochemical hydrogen pump 26 of the present embodiment, the deflection of first cathode separator 8c, second cathode separator 8d, and anode separator 7 is suppressed to the same extent as that of electrochemical hydrogen pump 24.

Moreover, as can be seen from FIG. 3E, the area of figure η is smaller than the area of figure a composed of 9fc, 9gc, and 9ec. Thus, in electrochemical hydrogen pump 26, the force of separating cathode end plate 14 from single battery cells m1a, m2a and m3a in the +Y direction is smaller than that of electrochemical hydrogen pump 24. Therefore, electrochemical hydrogen pump 26 achieved a fastening force of bolt 15 that is 0.8 times that of electrochemical hydrogen pump 24.

The thickness was modified in accordance with the above-mentioned fastening force in such a manner as to maintain the strength of each component, and as a result, the weight of electrochemical hydrogen pump 26 was 0.8 times the weight of electrochemical hydrogen pump 24.

Accordingly, while achieving an effect of suppressing the increase of the resistance to the same extent as that of electrochemical hydrogen pump 24, electrochemical hydrogen pump 26 has a weight that is approximately 0.8 times that is electrochemical hydrogen pump 24, and is therefore easy to handle for the household use.

In addition, in electrochemical hydrogen pump 26, for example, the introduction paths (29a, 29b, 29c and 29d) that communicate between cathode pressure space 28 and cathode inlet manifold 22a, and the introduction paths (29e, 29f, 29g and 29h) that communicate between cathode pressure space 28 and cathode outlet manifold 22f are provided in a shape of a plurality of steps. In addition, for example, the introduction paths (22t, 22s, 22p and 22o) that communicate between cathode electrode part 6 and cathode inlet manifold 22a, and the introduction paths (22v, 22u, 22r and 22q) that communicate between cathode electrode part 6 and cathode outlet manifold 22f are provided in a shape of a plurality of steps. Thus, in comparison with the case where above-mentioned introduction paths are provided in a shape of a single step (electrochemical hydrogen pump 24 of Embodiment 1), the length of each horizontal introduction path can be shortened. Accordingly, the diameter of the seal that surrounds each horizontal introduction path can be reduced. Thus, the force in the +Y direction and the −y direction due to high-pressure hydrogen can be reduced while reducing the increase of the resistance, and the fastening force of the bolt, i.e., the weight of electrochemical hydrogen pump 26 can be reduced.

In addition, since anode pressure space 27 includes the first space part, the second space part, and the fifth space part, and cathode pressure space 28 includes the third space part, the fourth space part, and the sixth space part, electrochemical hydrogen pump 26 of the present embodiment can reduce the total area of the space parts, and can suppress the resistance ratio at a sufficient level for a pump performance.

Embodiments 1 to 3 of the present disclosure are described above. Comparison between a known technology (for example, the electrochemical hydrogen pump illustrated in FIG. 2) and electrochemical hydrogen pumps 24 to 26 of Embodiments 1 to 3 is described below with reference to Table 1.

TABLE 1

| | Known | Embodiment | Embodiment | Embodiment |
|---|---|---|---|---|
| | Technology | 1 | 2 | 3 |
| Pressure | N/A | See FIG. 3C | See FIG. 3D | See FIG. 3E |
| Space | | | | |
| Resistance | Poor | Fair | Good | Fair |
| Ratio at | 96 | 28 | 4 | 26 |
| Pressure | | | | |
| Ratio 100 | | | | |
| Projection | — | Fair | Poor | Good |
| Area | | 49 | 100 | 31 |

Table 1 is a list of the presence/absence and the structure of the pressure space, the resistance ratio in an operation with a pressure ratio 100, and the area (projection area) the figure of the pressure space projected in the stacking direction in an example according to the known technology and examples according to Embodiments 1 to 3.

Specifically, the numerical values 96, 28, 4 and 26 in “Resistance Ratio at Pressure Ratio 100” in Table 1 are y-coordinate values of a, b, c and d at the right end in FIG. 7. In addition, the numerical values 49, 100 and 31 in “Projection Area” in Table 1 are the ratios of the areas of the hatching part of the figures of FIG. 3C, FIG. 3D and FIG. 3E, with respect to the area of the hatching part of FIG. 3D set as 100.

In the example according to the known technology, the resistance ratio at the pressure ratio of 100 is 96, whereas in the example according to Embodiments 1 to 3, even the largest resistance ratio is as small as approximately one third of 96, which causes no problem in practical use as a hydrogen compressor.

Especially in the example according to Embodiment 2, the resistance ratio at the pressure ratio of 100 is 4, which is significantly small in comparison with the resistance ratios of the examples according to Embodiments 1 and 3. However, to achieve such a low resistance ratio, the area (i.e., the projection area) of the figure obtained by projecting the pressure space in the stacking direction is 100, which is large in comparison with the projection areas of the examples according to Embodiments 1 and 3. Embodiment 2 is especially preferable from the viewpoint of reducing the resistance ratio. It should be noted that the end plate requires rigidity of the members such as the fastening bolt, and is heavy in weight, and, may cause a problem of handleability.

On the other hand, in the examples according to Embodiments 1 and 3, the resistance ratio is larger than Embodiment 2, but the area of the figure obtained by projecting the pressure space in the stacking direction can be set to a half or small size of that of Embodiment 2 while suppressing the resistance ratio to a level that causes no practical problem as a hydrogen compressor. Thus, the structure of Embodiment 2 becomes unnecessary, and the weight can be reduced. Therefore, Embodiments 1 and 3 can achieve an optimum, lightweight and compact structure for a household hydrogen compressor.

### Conclusion of Present Disclosure

The conclusion of the present disclosure is as follows.

An electrochemical hydrogen pump according to the present disclosure includes: at least one single battery cell including an anode separator, an anode diffusion layer, an anode electrode layer, an electrolyte membrane, a cathode electrode layer, a cathode diffusion layer, and a cathode separator; and an anode side member and a cathode side member provided to sandwich the at least one single battery cell. A pressure space is provided at a position where the anode diffusion layer and the cathode diffusion layer are sandwiched, and the pressure space includes an anode pressure space provided in the anode side member, and a cathode pressure space provided in the cathode side member.

The electrochemical hydrogen pump according to the present disclosure further includes a power source connecting member configured to be connected to a power source between the at least one single battery cell and at least one of the anode side member and the cathode side member. The pressure space is located outside the power source connecting member in a stacking direction of the at least one single battery cell.

In the electrochemical hydrogen pump according to the present disclosure, the pressure space is communicated with the cathode manifold through a first introduction path. The cathode electrode layer is communicated with the cathode manifold through the second introduction path.

In the electrochemical hydrogen pump according to the present disclosure, the pressure space has a cylindrical shape whose central axis is parallel to a stacking direction of the at least one single battery cell. The pressure space is surrounded by a seal having a same central axis as the central axis of the pressure space.

In the electrochemical hydrogen pump according to the present disclosure, the first introduction path and the second introduction path are surrounded by a seal whose central axis is parallel to the central axis of the pressure space.

In the electrochemical hydrogen pump according to the present disclosure, a first figure obtained by projecting the seal that surrounds the pressure space and the seal that surrounds the first introduction path on one flat surface perpendicular to the stacking direction is congruent with a second figure obtained by projecting a seal that surrounds the cathode electrode layer and the seal that surrounds the second introduction path on the flat surface.

In the electrochemical hydrogen pump according to the present disclosure, a third figure obtained by projecting the seal that surrounds the pressure space and the seal that surrounds the first introduction path on one flat surface perpendicular to the stacking direction is larger in area than a fourth figure obtained by projecting a seal that surrounds the cathode electrode layer and the seal that surrounds the second introduction path on the flat surface. The fourth figure is included in the third figure.

In the electrochemical hydrogen pump according to the present disclosure, a fifth figure obtained by projecting the seal that surrounds the first introduction path and the seal that surrounds the second introduction path on one flat surface perpendicular to the stacking direction when each of the first introduction path and the second introduction path is provided in a shape of a plurality of steps is smaller in area than a sixth figure obtained by projecting the seal that surrounds the first introduction path and the seal that surrounds the second introduction path on the flat surface when each of the first introduction path and the second introduction path is provided in a shape of a single step.

In the electrochemical hydrogen pump according to the present disclosure, the anode pressure space includes: a first space part formed to include the cathode diffusion layer as viewed in the stacking direction, and a second space part communicated with the first space part and the cathode manifold and formed to include the second introduction path as viewed in the stacking direction at a position where the second space part does not at least partly overlap the first space part as viewed in a direction perpendicular to the stacking direction. The cathode pressure space includes: a third space part formed to include the cathode diffusion layer as viewed in the stacking direction, and a fourth space part communicated with the third space part and the cathode manifold and formed to include the second introduction path as viewed in the stacking direction at a position where the fourth space part does not at least partly overlap the third space part as viewed in the direction perpendicular to the stacking direction.

In the electrochemical hydrogen pump according to the present disclosure, the anode pressure space includes: a first space part formed to include the cathode diffusion layer as viewed in the stacking direction, a second space part communicated with the first space part and formed to include a part of the second introduction path as viewed in the stacking direction at a position where the second space part does not at least partly overlap the first space part as viewed in the direction perpendicular to the stacking direction, and a fifth space part communicated with the second space part and the cathode manifold and formed to include a part of the second introduction path as viewed in the stacking direction at a position where the fifth space part does not at least partly overlap the second space part as viewed in the direction perpendicular to the stacking direction. The cathode pressure space includes: a third space part formed to include the cathode diffusion layer as viewed in the stacking direction, a fourth space part communicated with the third space part and formed to include a part of the second introduction path as viewed in the stacking direction at a position where the fourth space part does not at least partly overlap the third space part as viewed in the direction perpendicular to the stacking direction, and a sixth space part communicated with the fourth space part and the cathode manifold and formed to include a part of the second introduction path as viewed in the stacking direction at a position where the sixth space part does not at least partly overlap the fourth space part as viewed in the direction perpendicular to the stacking direction. As viewed in the stacking direction, an entirety of the second introduction path is included in at least one of the second space part and the fifth space part. As viewed in the stacking direction, the entirety of the second introduction path is included in at least one of the fourth space part and the sixth space part.

The present disclosure is not limited to the description of each of the above forms, and various variations are possible to the extent that the purpose thereof is not deviated from.

This application is entitled to and claims the benefit of Japanese Patent Application No. 2018-208958 filed on Nov. 6, 2018, the disclosure each of which including the specification, drawings and abstract is incorporated herein by reference in its entirety.

### INDUSTRIAL APPLICABILITY

The electrochemical hydrogen pump of the present disclosure may be used as a hydrogen compression apparatus for a hydrogen filling apparatus. Further, the structure of the electrochemical hydrogen pump of the present disclosure may be used as an electrochemical water electrolysis system that generates hydrogen and oxygen by electrolysis of water.

### REFERENCE SIGNS LIST

1 Power generation stack
2 Electrolyte membrane
3 Anode electrode layer
4 Cathode electrode layer
5 Anode diffusion layer
6 Cathode diffusion layer
7 Anode separator
7a A-end separator
7b First A-end separator
7c Second A-end separator
8 Cathode separator
8a C-end separator
8b C-pressure plate
8c First cathode separator
8d Second cathode separator
8e First C-end separator
8f Second C-end separator
9a, 9b, 9c, 9d, 9e, 9f, 9g, 9h, 9i, 9j, 9k, 30a, 30b, 30c, 30d, 30e, 30f, 30g, 30h, 30i, 30j, 30k, 30l Seal
9ac, 9bc, 9cc, 9dc, 9ec, 9fc, 9gc, 9hc, 9ic, 9jc, 9kc, 30ac, 30bc, 30cc, 30dc, 30ec, 30fc, 30gc, 30hc, 30ic, 30jc, 30kc, 30lc Seal center line
10 Nut
11 Anode insulation plate
12 Cathode insulation plate
13 Anode end plate
13a Box-shaped end plate
14 Cathode end plate
14a Cylinder
14b Lid-shaped end plate
14ba Space
14c Folder
14d Disc spring
15 Bolt
16 Anode inlet
17 Anode outlet
18 Cathode inlet
19 Cathode outlet
20 Power source
21a Anode inlet manifold
21b Anode inlet horizontal introduction path
21c Anode inlet vertical introduction path
21d Anode outlet vertical introduction path
21e Anode outlet horizontal introduction path
21f Anode outlet manifold
22a Cathode inlet manifold
22b, 22g, 22k, 22p, 22t, 29a, 29c, 29i, 29k Cathode inlet horizontal introduction path
22c, 22h, 22l, 22o, 22s, 29b, 29d, 29j, 29l Cathode inlet vertical introduction path
22d, 22j, 22n, 22q, 22u, 29f, 29h, 29n, 29p Cathode outlet vertical introduction path
22e, 22i, 22 m, 22r, 22v, 29e, 29g, 29m, 29o Cathode outlet horizontal introduction path
22f Cathode outlet manifold
23, 24, 25, 26 Electrochemical hydrogen pump
27 Anode pressure space
28 Cathode pressure space
31 Evaluation apparatus
32 Hydrogen cylinder
33 Regulator
34 Bubbler
35 Heater
36 Gas-liquid separation apparatus
37 Cooling apparatus
38 Pressure gauge
39 Exhaust valve
40 Nitrogen cylinder
41 Dilution apparatus
42 Exhaust port
43 Three-way valve
44 Valve
45 Valve
A +y, −y, ±y direction
m1, m2, m3, m1a, m2a, m3a Single battery cell
a, b, c, d Plot
F1, F2, A1 Force

1. An electrochemical hydrogen pump comprising:
at least one single battery cell including an anode separator, an anode diffusion layer, an anode electrode layer, an electrolyte membrane, a cathode electrode layer, a cathode diffusion layer, and a cathode separator; and
an anode side member and a cathode side member provided to sandwich the at least one single battery cell,
wherein a pressure space is provided at a position where the anode diffusion layer and the cathode diffusion layer are sandwiched, and
wherein the pressure space includes an anode pressure space provided in the anode side member, and a cathode pressure space provided in the cathode side member.

2. The electrochemical hydrogen pump according to claim 1, further comprising a power source connecting member configured to be connected to a power source between the at least one single battery cell and at least one of the anode side member and the cathode side member, and
wherein the pressure space is located outside the power source connecting member in a stacking direction of the at least one single battery cell.

3. The electrochemical hydrogen pump according to claim 1,
wherein the pressure space is communicated with the cathode manifold through a first introduction path; and
wherein the cathode electrode layer is communicated with the cathode manifold through the second introduction path.

4. The electrochemical hydrogen pump according to claim 3,
wherein the pressure space has a cylindrical shape whose central axis is parallel to a stacking direction of the at least one single battery cell; and
wherein the pressure space is surrounded by a seal having a same central axis as the central axis of the pressure space.

5. The electrochemical hydrogen pump according to claim 4, wherein the first introduction path and the second introduction path are surrounded by a seal whose central axis is parallel to the central axis of the pressure space.

6. The electrochemical hydrogen pump according to claim 5, wherein a first figure obtained by projecting the seal that surrounds the pressure space and the seal that surrounds the first introduction path on one flat surface perpendicular to the stacking direction is congruent with a second figure obtained by projecting a seal that surrounds the cathode electrode layer and the seal that surrounds the second introduction path on the flat surface.

7. The electrochemical hydrogen pump according to claim 5,
wherein a third figure obtained by projecting the seal that surrounds the pressure space and the seal that surrounds the first introduction path on one flat surface perpendicular to the stacking direction is larger in area than a fourth figure obtained by projecting a seal that surrounds the cathode electrode layer and the seal that surrounds the second introduction path on the flat surface; and
wherein the fourth figure is included in the third figure.

8. The electrochemical hydrogen pump according to claim 5, wherein a fifth figure obtained by projecting the seal that surrounds the first introduction path and the seal that surrounds the second introduction path on one flat surface perpendicular to the stacking direction when each of the first introduction path and the second introduction path is provided in a shape of a plurality of steps is smaller in area than a sixth figure obtained by projecting the seal that surrounds the first introduction path and the seal that surrounds the second introduction path on the flat surface when each of the first introduction path and the second introduction path is provided in a shape of a single step.

9. The electrochemical hydrogen pump according to claim 3,
wherein the anode pressure space includes:
a first space part formed to include the cathode diffusion layer as viewed in the stacking direction, and
a second space part communicated with the first space part and the cathode manifold and formed to include the second introduction path as viewed in the stacking direction at a position where the second space part does not at least partly overlap the first space part as viewed in a direction perpendicular to the stacking direction; and
wherein the cathode pressure space includes:
a third space part formed to include the cathode diffusion layer as viewed in the stacking direction, and
a fourth space part communicated with the third space part and the cathode manifold and formed to include the second introduction path as viewed in the stacking direction at a position where the fourth space part does not at least partly overlap the third space part as viewed in the direction perpendicular to the stacking direction.

10. The electrochemical hydrogen pump according to claim 3,
wherein the anode pressure space includes:
a first space part formed to include the cathode diffusion layer as viewed in the stacking direction,
a second space part communicated with the first space part and formed to include a part of the second introduction path as viewed in the stacking direction at a position where the second space part does not at least partly overlap the first space part as viewed in the direction perpendicular to the stacking direction, and
a fifth space part communicated with the second space part and the cathode manifold and formed to include a part of the second introduction path as viewed in the stacking direction at a position where the fifth space part does not at least partly overlap the second space part as viewed in the direction perpendicular to the stacking direction;
wherein the cathode pressure space includes:
a third space part formed to include the cathode diffusion layer as viewed in the stacking direction,
a fourth space part communicated with the third space part and formed to include a part of the second introduction path as viewed in the stacking direction at a position where the fourth space part does not at least partly overlap the third space part as viewed in the direction perpendicular to the stacking direction, and
a sixth space part communicated with the fourth space part and the cathode manifold and formed to include a part of the second introduction path as viewed in the stacking direction at a position where the sixth space part does not at least partly overlap the fourth space part as viewed in the direction perpendicular to the stacking direction,
wherein as viewed in the stacking direction, an entirety of the second introduction path is included in at least one of the second space part and the fifth space part; and
wherein as viewed in the stacking direction, the entirety of the second introduction path is included in at least one of the fourth space part and the sixth space part.
